(19) United States
(12) Patent Application Publication
(10) Pub. No.: US 2013/0293731 A1
(43) Pub. Date: Nov. 7, 2013

(54) REMOTE CONTROLLER DEVICE FOR SELF-PHOTOGRAPHY USING A MOBILE PHONE CAMERA

(71) Applicant: Ki yeon Kim, Daejeon (KR)

(72) Inventor: Ki yeon Kim, Daejeon (KR)

(21) Appl. No.: 13/979,693

(22) PCT Filed: Oct. 31, 2011
(86) PCT No.: PCT/KR2011/008181

§ 371 Date: Jul. 15, 2013

(30) Foreign Application Priority Data
Jan. 13, 2011 (KR) 10-2011-0003409

(51) Int. Cl. H04N 5/232

(52) U.S. Cl. CPC H04N 5/23203
USPC 348/211.2

(57) ABSTRACT

The present invention relates to a device for increasing self-photographing distance using a mobile phone camera, and more particularly, to a remote control for self-photography with a mobile phone camera for wirelessly operating a switch of a mobile phone by using wireless communication and an electromagnet in order to increase the distance to a limit of self-photographing, which was previously limited because the switch needed to be manually operated during self-photographing with the mobile phone camera.

### TECHNICAL FIELD

The present invention relates to a wireless remote control for self-photographing with a mobile phone camera, and more particularly, to a remote control for self-photographing with a mobile phone camera, in which a camera switch of a mobile phone is turned on by a wireless means in order to increase the distance to a limit that is caused since the switch must be manually operated during self-photographing with the mobile phone camera.

### BACKGROUND ART

Recently, mobile phones are equipped with a camera, and self-photographing with a mobile phone camera has become popular. Self-photographing has a merit in that a user can take his/her own picture not only at home but also during travel without asking other persons for a favor. Therefore, it is expected that self-photographing will be used more widely.

In a mobile phone, a camera lens for self-photographing and a lens for recording dynamic images are disposed such that they face opposite directions. In order to operate the camera, a specific switch of the mobile phone must be physically operated with a hand or a hand-manipulated tool. Therefore, it is possible to take a picture within a short distance to which his/her hand can reach. In the case of photographing at a short distance, a face may be distorted due to the characteristics of the lens, which is problematic. In addition, the face of the user is always enlarged in the picture. Furthermore, it is impossible to take a picture of several people, as in the case of a family picture, at that distance.

Recently, a handle-type tripod as shown in FIG. 1 was developed by improving a tripod of a typical camera. This is a valuable technology for increasing the distance of self-photographing with a camera. However, this technology is intended merely to increase the photographing distance, but does not have the function of operating a camera switch. Therefore, it is required to use a camera timer equipped in the camera in order to take a picture. However, the use of the camera timer requires a waiting time, which disadvantageously makes it difficult to take a picture in real time.

The recent switch function of mobile phones is provided as a screen touch type that is more advanced than a button type. Screen touch technologies that are generally used include a pressure sensing type which senses pressure applied to a screen and a capacitive sensing type which senses a change in static electricity that is applied to the screen. In addition, a screen touch pen was developed in order to overcome difficulties that occur when operating the touch screen with a hand.

The function of such a touch screen fails to overcome its limitations in which a hand or a hand-manipulated tool must be used in order to enable the function. Therefore, the existing problem involved in self-photographing with a mobile phone still remains unimproved.

### DISCLOSURE

### Technical Problem

The present invention has been made to solve the foregoing problems with the prior art, and therefore the present invention provides a technology for increasing the distance of self-photographing by remotely controlling a camera switch of a mobile phone based on the existing wireless communication control technology, i.e. a frequency control technology or an infrared (IR) control technology, and using an electromagnet.

For this, the present invention includes a wireless communication transmitter, a wireless communication receiver, an electromagnet and a camera switch touch rod which is actuated by the electromagnet.

The present invention is intended to increase the distance of self-photographing with the mobile phone camera irrespective of time and place by employing a remote control which is based on wireless communication and the switch touch rod which is actuated by the electromagnet. Accordingly, a user can take a variety of pictures, including family pictures, by himself/herself without asking anyone for a favor. In addition, it is also possible to easily take a picture in a theater or the like, the conditions of which make it difficult to take a picture.

Furthermore, the present invention is also intended to increase the ease of use of a mobile phone by employing a screen touch pen which is disposed therein. The present invention also provides a mobile phone mounting function and thus can be used as a mobile phone mount when a user watches a TV program using the mobile phone.

### Technical Solution

As shown in FIG. 2, the present invention has four parts in order to realize the forgoing object.

Specifically, the present invention includes a handle part (10), a mobile phone mounting part (20), a multi-stage shaft (30) and a protective cover (40). The handle part (10) has a wireless communication transmitter which is disposed therein. The mobile phone mounting part has a wireless communication receiver module which is disposed therein. The mobile phone mounting part also includes an electromagnet, a switch touch rod which operates in response to the electromagnet, and a mobile phone holder by which a mobile phone can be held. With the mobile phone mounting part (20), it is possible to change the direction of the mobile phone as required. The multi-stage shaft (30) connects the handle part and the mobile phone mounting part to each other, and is adjustable in length. The protective cover (40) is coupled with the handle part in order to protect the mobile phone mounting part while being carried.

### Advantageous Effects

As set forth above, the remote control for self-photographing with a mobile phone camera according to the present invention increases the distance of self-photographing with the mobile phone camera to be greater than that of mobile phone cameras of the related art. Accordingly, a user can take a picture of himself/herself or a family picture at a desirable distance without help from anyone, and easily take a picture in a theater or the like where it is difficult to take a picture. In addition, the remote control also has an additional effect in that it can be used as a mobile phone mount when the user watches a TV program using the mobile phone.

### DESCRIPTION OF DRAWINGS

FIG. 1 is a view showing a handle-type tripod of the related art;

FIG. 2 is a perspective view showing components of the present invention as well as the stage in which the present invention is in use;

FIG. 3 is a cross-sectional view showing the structure of a handle part and a multi-stage shaft of the present invention;

FIG. 4 is a cross-sectional view showing the structure of a mobile phone mounting part of the present invention;

FIG. 5 is a cross-sectional view showing the operation when a mobile phone is mounted on the mobile phone mounting part of the present invention;

FIG. 6 is a cross-sectional view showing the shape in which the direction of the mobile phone mounting part is changed in order to self-photograph dynamic images using the present invention;

FIG. 7 is a cross-sectional view showing the structure of a mobile phone holder of the present invention;

FIG. 8 is a cross-sectional view showing the structure of a case of the mobile phone mounting part of the present invention;

FIG. 9 is a cross-sectional view showing the structure of a direction-changing block of the mounting part of the present invention;

FIG. 10 is a view showing an electric circuit of the present invention;

FIG. 11 is a perspective view showing the concept of the operation of the present invention;

FIG. 12 is a perspective view showing the shape in which the present invention is used as a mobile phone mount; and

FIG. 13 is a cross-sectional view showing an example in which the present invention is put into practice using a solenoid.

### MODE FOR INVENTION

The above and other aspects and features of the present invention will now be described more fully hereinafter with reference to the accompanying drawings.

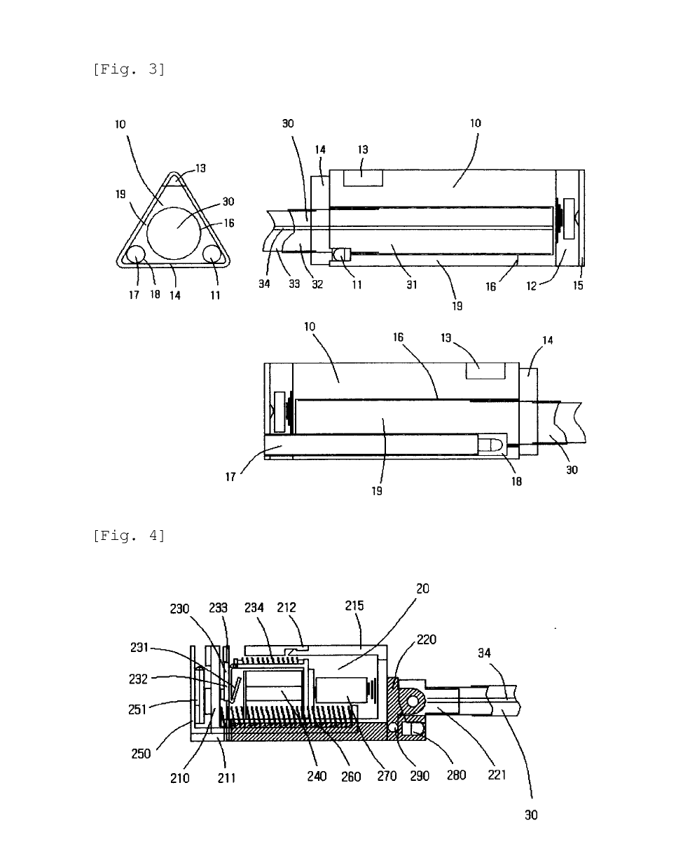

As shown in FIG. 3, the handle part 10 includes a wireless communication transmitter 11, a transmitter battery case 12 which can house a small battery therein, a transmitter switch 13 which can supply power to the wireless communication transmitter as required, a protective cover connection block 14 which can fix the protective cover 40, a screen touch pen 17, and a handle case 19 to which a multi-stage shaft 30 can be coupled and the above-mentioned components can be assembled.

The wireless communication transmitter 11 is provided in the front part of the handle case 19 in order to facilitate interaction with a wireless communication receiver module 280 which is provided in the mobile phone mounting part 20, as shown in FIG. 4. In response to the operation of the transmitter switch 13, a frequency or infrared (IR) signal is transmitted from the wireless communication transmitter to the wireless communication receiver module 280. The wireless communication transmitter 11 operates only when a user manipulates the transmitter switch 13.

The transmitter battery case 12 is located at a rear surface of the handle case, and a battery case cover 15 is provided whereby the user can conveniently replace a battery.

The transmitter switch 13 is located at the upper end of the handle case, whereby the user can conveniently manipulate it with one hand.

The protective cover connection block 14 serves to couple the protective cover 40 to the handle part 10 when the user does not use the present invention.

The screen touch pen 17 is stored in a touch pen storage recess 18, and is configured such that it can be independently drawn out and used as required.

The handle case 19 has a shaft connection groove 16 to which the multi-stage shaft 30 which is adjustable in length can be coupled. The handle case 19 is configured such that the wireless communication transmitter, the battery case and the switch, or the components of the handle part, can be assembled thereto, and the screen touch pen can be stored therein. The handle case 19 can also be coupled with the protective cover 40.

In other words, the handle part 10 serves to deliver the intention of the user to take a picture to the mobile phone mounting part 20 using the wireless communication transmitter.

As shown in FIG. 4, the mobile phone mounting part 20 can include a mounting part case 210 and a mounting part direction-changing block 220. The mounting part case 210 houses therein a camera switch touch rod 230 which can operate a camera switch of a mobile phone, an electromagnet 240 which can actuate the camera switch touch rod, a mobile phone holder 250 which is actuated by a holder spring 260 in order to affix the mobile phone to the mobile phone mounting part 20, and a receiver battery case 270 in which a small battery can be disposed. The mounting part case 210 can be attached to and detached from the mounting part direction-changing block 220 in order to change, as required, the direction in which the mobile phone takes a picture. The mounting part direction-changing block 220 includes the wireless communication receiver module 280, a receiver switch 290 which can turn off power, and a shaft connection block 221 which can be connected to the multi-stage shaft 30 and is adjustable in angle. Accordingly, the mounting part case 210 can be attached to and detached from the mounting part direction-changing block 220.

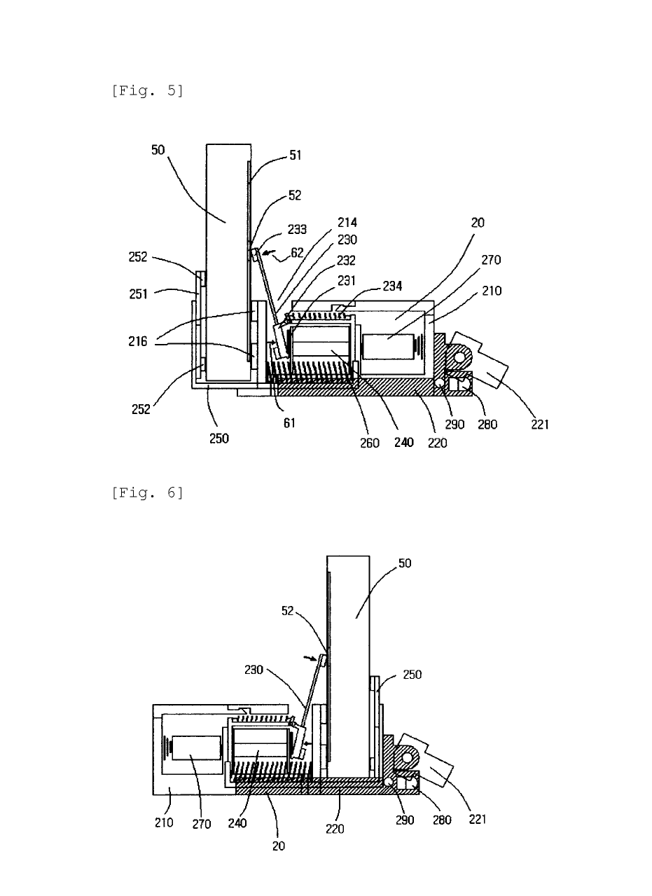

As shown in FIG. 5, when a magnetic plate 231 is strongly moved in the direction 61 toward the electromagnet by a magnetic force in response to an action of the electromagnet 240, a switch contact plate 233 of the camera switch touch rod 230 moves in the opposite direction, i.e. the direction 62 toward the mobile phone 50, thereby operating a camera switch 52 of the mobile phone. The camera switch touch rod 230 is designed such that it has a multi-stage structure 232. The camera switch touch rod 230 stays inside the mounting part case 210 at normal times but its length is manually increased by the user only when it is used. The switch contact plate 233 which comes into direct contact with a switch plate 51 of the mobile phone 50 uses an existing capacitive touch pen technology such that it can be applied to a capacitive touch screen of the mobile phone 50. The switch contact plate 233 is held at a predetermined distance from the mobile phone switch plate 51 by a touch rod spring 234 at normal times, but touches the camera switch 52 of the mobile phone only when the electromagnet 240 operates, whereby photographing with the mobile phone is conducted.

The electromagnet 240 acts as a magnet only when power is supplied thereto, and serves to strongly pull the magnetic plate 231 of the switch touch rod.

The interval of the mobile phone holder 250 in which the mobile phone is received can be adjusted by the holder spring 260, such that the mobile phone holder can be applied to a variety of thicknesses of mobile phones. As shown in FIG. 7, for coupling with the holder spring 260, the mobile phone holder 250 has two support plates 253 and two spring connection plates 254. In addition, the mobile phone holder 250 also has a foldable support 251, whereby the mobile phone holder 250 maintains the erected state by a manual operation of the user only when it is used. A silicone 252 is attached to one surface of the mobile phone support 251 in order to prevent the mobile phone from slipping or being dislodged. The mobile phone holder 250 fixes the mobile phone to the mounting part 20, and when the mobile phone is mounted, serves to always maintain the distance between the mobile phone switch plate 51 and the switch contact plate 233 at a fixed value.

The receiver battery case 270 can house therein a small battery, and has a receiver battery case cover 215, whereby the user can easily replace the battery.

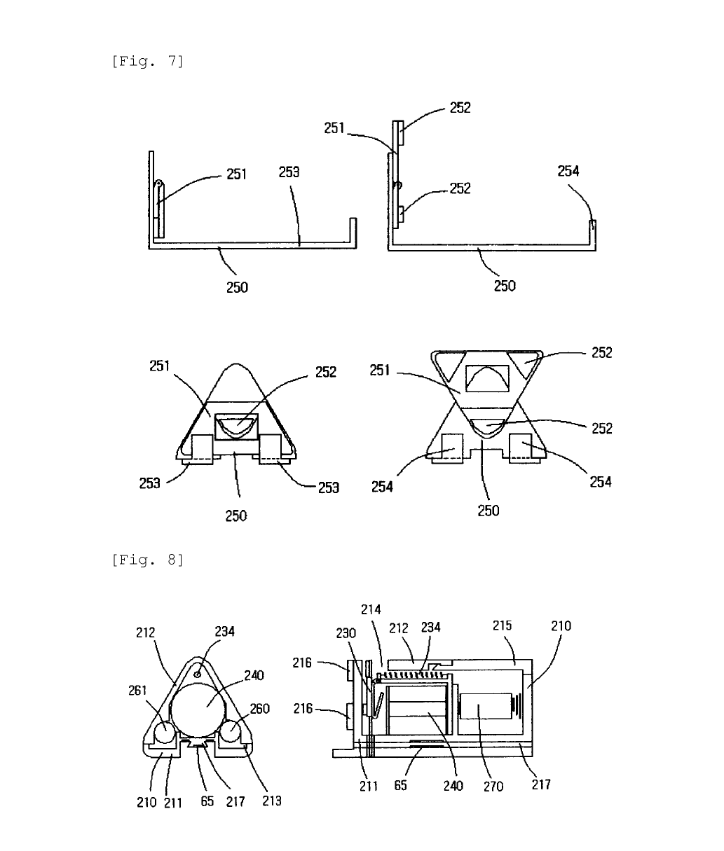

As shown in FIG. 8, the mounting part case 210 includes a base 211 and a cover 212. The case base 211 has a holder recess 213 in the front surface thereof, the holder recess 213 being designed such that the mobile phone holder 250 is coupled thereto. The case base 211 has two spring passages 261 therein which help the holder spring 260 smoothly operate. The case base 211 has a direction-changing tunnel 217 in the bottom, whereby the case base can be attached to and detached from the mounting part direction-changing block 220. A power connection terminal 65 is provided in the direction-changing tunnel, and is configured such that power is connected when the direction is changed. The case cover 212 has an open recess 214 in the top portion thereof which allows the camera switch touch rod 230 to move and a receiver battery case cover 215 which facilitates the replacement of the battery. In addition, a silicone 216 is attached to the case cover 212, and cooperates with the silicone 252 of the mobile phone holder 250 in order to prevent the mobile phone from slipping or being dislodged.

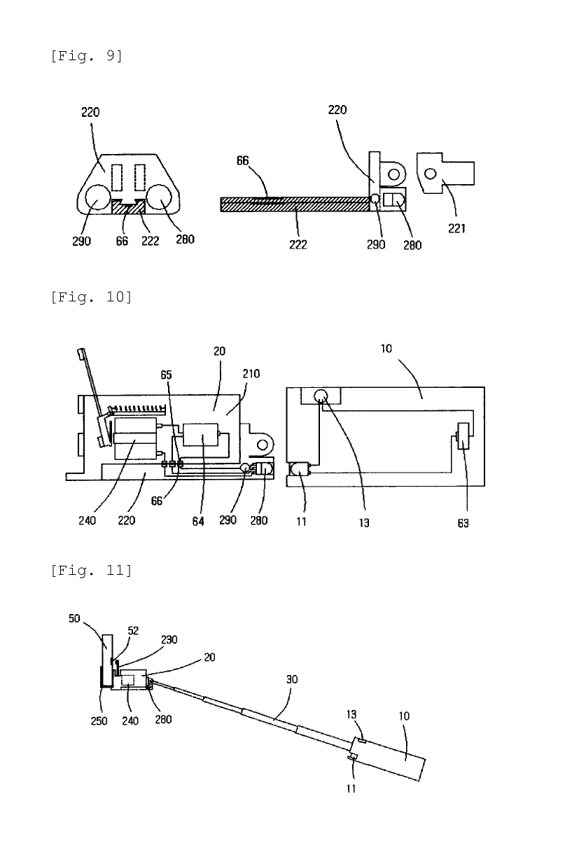

As shown in FIG. 9, the mounting part direction-changing block 220 includes the wireless communication receiver module 280, the receiver switch 290, the shaft connection block 221 and a case connection rail 222 which is intended for attachment to and detachment from the mounting part case 210. The connection rail has a changing block power connection terminal 66 which can contact the case power connection terminal 65 of the mounting part case 210. The shaft connection block 221 can be connected to the multi-stage shaft 30, and adjust the angle between the shaft 30 and the mobile phone mounting part 20. The angle adjustment function is also important since the handle part 10 is always photographed in the case of a linear shape in which the angle is not adjusted.

The wireless communication receiver module 280 is located at the rear side of the mounting part direction-changing block 220 in order to interact with the wireless communication transmitter 11 of the handle part 10, and serves to actuate the electromagnet 240 by supplying power to it in response to a signal from the wireless communication transmitter.

Power consumption occurs when the present invention is not used considering the characteristic of a wireless communication receiver device which is required to constantly maintain the power-on state. Accordingly, when the present invention has not been used for a long time, the receiver switch 290 turns off power in order to prevent unnecessary power consumption.

As such, the mobile phone mounting part 20 serves as a mount to which the mobile phone 50 is affixed, and actuates the electromagnet 240 in response a signal from the wireless communication transmitter 11 so that the camera switch touch rod 230 operates the camera switch 52 of the mobile phone. In addition, since the direction of the mobile phone 50 must be changed during self-photographing of dynamic images, the mounting part case 210 is separated from the mounting part direction-changing block 220 along the connection rail 222, and is coupled again after its direction is changed. Accordingly, this makes it possible to take dynamic images in the opposite direction, as shown in FIG. 6, i.e. the direction toward the user.

As shown in FIG. 3, one surface of the multi-stage shaft 30 is coupled to the handle part 10. It is possible to adjust the length of the multi-stage shaft by drawing it out when in use. The other surface is connected to the shaft connection block 221 of the mobile phone mounting part 20. An anti-rotation recess 34 is designed in each of unit shafts 31, 32 and 33 in a predetermine direction in order to prevent the unit shafts from arbitrarily rotating.

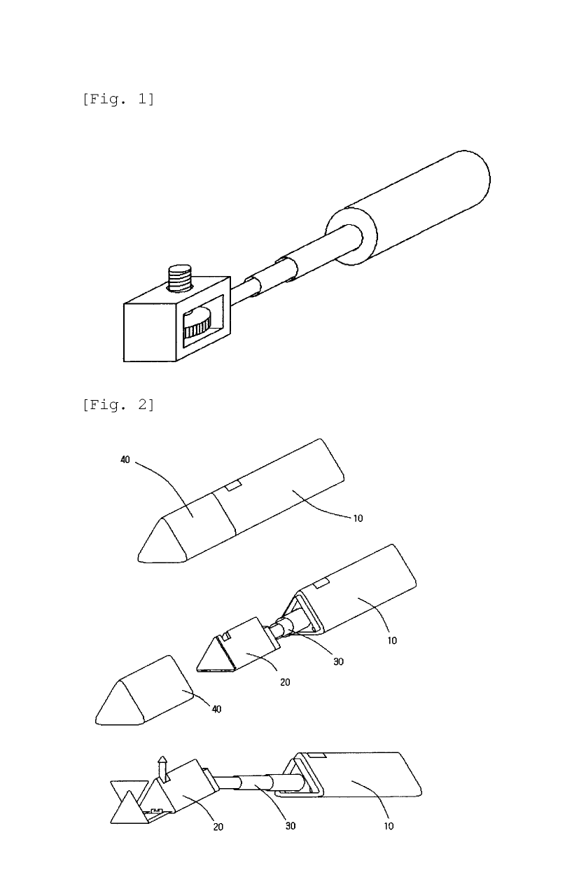

When the user is not using the present invention, the protective cover 40 is coupled with the handle part 10, as shown in FIG. 2, in order to protect the mobile phone mounting part 20.

Referring to a circuit diagram shown in FIG. 10, in the handle part 10, one circuit line from a battery 63 is directly connected to the wireless communication transmitter 11, and another circuit line from the battery is connected to the wireless communication transmitter 11 via the transmitter switch 13. In the mobile phone mounting part 20, one circuit line from a battery 64 is directly connected to the wireless communication receiver module 280 and the electromagnet 240, another circuit line is connected to the wireless communication receiver module 280 via the receiver switch 290, and one separate circuit line from the wireless communication receiver module 280 is connected to the electromagnet 240. Since the present invention is characterized in that the mounting part case 210 and the mounting part direction-changing block 220 can be separated from and coupled again with each other, the power connection terminals 65 and 66 are provided between the direction-changing tunnel 217 and the connection rail 222 such that power can be connected when the direction is changed.

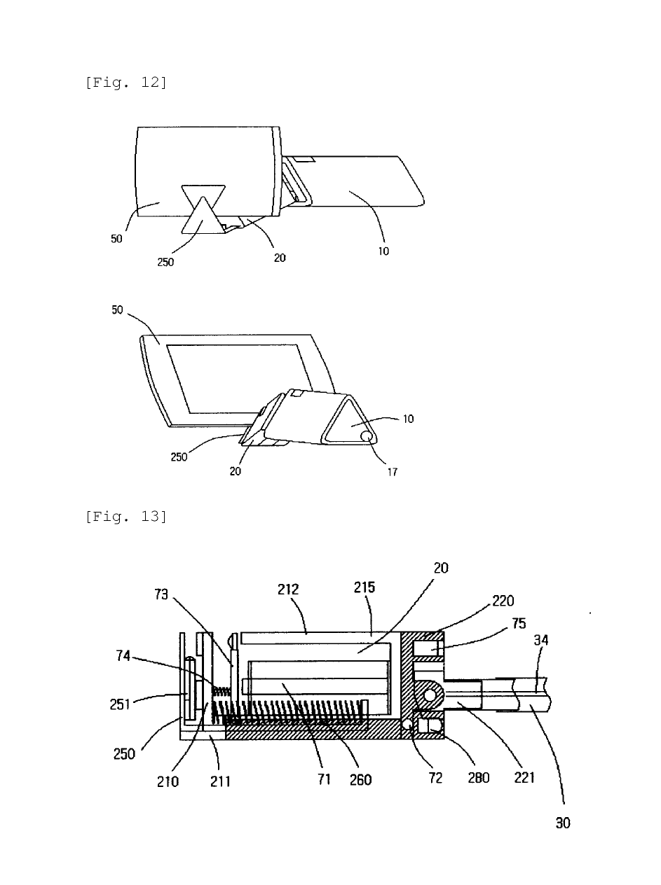

Referring to the operating principle of the present invention, as shown in FIG. 11, when a wireless communication signal is transmitted via the wireless communication transmitter 11 in response to the manipulation of the handle part 10 and the transmitter switch 13, the mobile phone mounting part 20 which is spaced apart from the handle part detects the signal via the wireless communication receiver module 280 and supplies power to the electromagnet 240 so that the electromagnet generates a magnetic force. The magnetic force actuates the camera switch touch rod 230, whereby the camera switch 52 of the mobile phone 50 which is mounted on the mobile phone mounting part 20 by the mobile phone holder 250 is operated, so that the camera takes a picture.

When self-photographing dynamic images, the mounting part case 210 is separated from the mounting part direction-changing block 220 and is coupled again to the mounting part direction-changing block in the opposite direction, so that photographing can be conducted with the mobile phone by changing the photographing direction.

When used as a mobile phone mount, as shown in FIG. 12, the present invention is used after the mobile phone 50 is mounted on the mobile phone mounting part 20 without the shaft being drawn out. The screen touch pen 17 is independently used by being drawn out from the handle part 10 irrespective whether or not the present invention is in use.

As another embodiment of the invention, a solenoid technology to which an electromagnet is applied can be used. As shown in FIG. 13, a solenoid 71 which substitutes the electromagnet is provided inside the mounting part case 210 of the mobile phone mounting part 20. For a power source, the battery of the mobile phone is used. For this, a battery connection terminal 72 which can be connected to the mobile phone battery via a separate external line is provided. In this case, the position of the touch rod spring 74 is designed in the opposite direction such that the switch touch rod 73 has a returning function even if the solenoid operates in the opposite direction from the electromagnet.

In addition, the mounting part direction-changing block 220 can be provided with a camera flash 75 so as to be used for a mobile phone without a camera flash.

The present invention is a valuable technology in that it has a simple structure since it uses the wireless remote switch based on the electromagnet and wireless communication. Since the multi-stage shaft is used, the volume is reduced and the present invention can be easily carried. The user can conveniently increase the distance of self-photographing with the mobile phone irrespective of time and place. The present invention can be used as a mobile phone mount as required, and can house the screen touch pen therein and make use of it.

1. A remote control for self-photographing with a mobile phone camera which is used as an auxiliary device for photographing with the camera, comprising:
a handle part, wherein the handle part comprises:
a wireless communication transmitter;
a transmitter battery capable of housing a battery therein; and
a transmitter switch capable of supplying power to the wireless communication transmitter as required; and
a mobile phone mounting part, wherein the mobile phone mounting part comprises:
a wireless communication receiver module;
a receiver battery case capable of housing a battery therein;
a receiver switch capable of turning off power when the remote control is not in use;
an electromagnet which operates in connection with the wireless communication receiver module;
a camera switch touch rod including a magnetic plate which responds to a magnetic force of the electromagnet; and
a mobile phone holder which is actuated by a holder spring so as to hold a variety of thicknesses of mobile phones.

2. A remote control for self-photographing with a mobile phone camera which is used as an auxiliary device for photographing with the camera, comprising:
a handle part, wherein the handle part comprises:
wireless communication transmitter;
a transmitter battery case capable of housing a battery therein; and
a transmitter switch capable of supplying power to the wireless communication transmitter as required; and
a mobile phone mounting part, wherein the mobile phone mounting part comprises:
a wireless communication receiver module;
a solenoid which operates in connection with the wireless communication receiver module;
a camera switch touch rod which is actuated by the solenoid;
a mobile phone holder which holds a variety of thicknesses of mobile phones; and
a camera flash.

3. The remote control according to claim 1, wherein:
the handle part further comprises a protective cover connection block at one side thereof to which a protective cover is coupled and a shaft connection recess to which a multi-stage shaft is to be coupled,
the mobile phone mounting part further comprises:
a mounting part direction-changing block having a shaft connection block at one side thereof, the shaft connection block enabling an angle at which the multi-stage shaft is connected to be adjusted, and a connection rail which enables a mounting part case to be separated from and coupled again to the mounting part direction-changing block; and
the mounting part case having a changing tunnel which enables the mounting part case to be connected to the mounting part direction-changing block, and the multi-stage shaft is adjustable in length, and has an anti-rotation recess in a surface thereof which prevents the multi-stage shaft from rotating freely,
the remote control further comprising a protective cover which is coupled to the protective cover connection block of the handle part to protect the mobile phone mounting part.

4. The remote control according to claim 1, wherein:
the handle part further comprises a mobile phone screen touch pen which can be drawn out independently, and
the mobile phone mounting part comprises:
a mounting part case which has a silicone on one surface thereof, the silicone preventing a mobile phone from slipping;
the camera switch touch rod having a multi-stage structure and being adjustable in length; and
the mobile phone holder comprising a silicone on one surface thereof, the silicone preventing the mobile phone from slipping, and a foldable support which is adjustable in length.

5. The remote control according to claim 2, wherein:
the handle part further comprises a protective cover connection block at one side thereof to which a protective cover is coupled and a shaft connection recess to which a multi-stage shaft is to be coupled,
the mobile phone mounting part further comprises:
a mounting part direction-changing block having a shaft connection block at one side thereof, the shaft connection block enabling an angle at which the multi-stage shaft is connected to be adjusted, and a connection rail which enables a mounting part case to be separated from and coupled again to the mounting part direction-changing block; and
the mounting part case having a changing tunnel which enables the mounting part case to be connected to the mounting part direction-changing block, and
the multi-stage shaft is adjustable in length, and has an anti-rotation recess in a surface thereof which prevents the multi-stage shaft from rotating freely,
the remote control further comprising a protective cover which is coupled to the protective cover connection block of the handle part to protect the mobile phone mounting part.

6. The remote control according to claim 2, wherein:
the handle part further comprises a mobile phone screen touch pen which can be drawn out independently, and
the mobile phone mounting part comprises:
a mounting part case which has a silicone on one surface thereof, the silicone preventing a mobile phone from slipping;
the camera switch touch rod having a multi-stage structure and being adjustable in length; and
the mobile phone holder comprising a silicone on one surface thereof, the silicone preventing the mobile phone from slipping, and a foldable support which is adjustable in length.
